(19) United States
(12) Patent Application Publication
(10) Pub. No.: US 2016/0188684 A1
(43) Pub. Date: Jun. 30, 2016

(54) Consolidating Search Results

(71) Applicant: Quixey, Inc., Mountain View, CA (US)

(72) Inventors: Eric J. Glover, Palo Alto, CA (US); Thomas Lee Francis, Dubuque, IA (US)

(73) Assignee: Quixey, Inc., Mountain View, CA (US)

(21) Appl. No.: 14/982,150

(22) Filed: Dec. 29, 2015

Related U.S. Application Data
(60) Provisional application No. 62/097,307, filed on Dec. 29, 2014.

(51) Int. Cl. G06F 17/30

(52) U.S. Cl. CPC G06F 17/30554; G06F 17/30477

(57) ABSTRACT

A method includes receiving, at a computing device, a search query from a remote device, identifying a preliminary set of application state records, selecting a primary application state record from the preliminary set of application state records, and identifying an entity name and action associated with the primary application state record. The method includes identifying a secondary application state record from the preliminary set with the same entity name as the primary application state record and a different action than the primary application state record. Additionally, the method includes generating a consolidated result based on the primary application state record and the secondary application state record, generating final search results based on the preliminary set of application state records, and transmitting final search results to the remote device. The search results include the consolidated results in addition to the search results based on the preliminary set of application state records.

### CROSS REFERENCE TO RELATED APPLICATIONS

This U.S. patent application claims priority under 35 U.S.C. §119(e) to U.S. Provisional Application 62/097,307, filed on Dec. 29, 2014, which is hereby incorporated by reference in its entirety.

### TECHNICAL FIELD

This disclosure relates to searching and accessing application functionality, and more particularly, to arranging search results.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications to games, educational applications, news applications, shopping applications, messaging applications, media streaming applications, social networking applications, and so much more. Furthermore, application developers develop vast amounts of applications within each genre and each application may have numerous editions. As a result, users of these Internet-connected devices have encountered the problem of finding the correct native or web software application offering the information and/or functionality that they seek. In response to this problem, techniques have arisen to connect users of these devices to relevant application and web content.

### SUMMARY

The details of one or more implementations of the disclosure are set forth in the accompanying drawings and the description below. Other aspects, features, and advantages will be apparent from the description and drawings, and from the claims.

In one example, the present disclosure is directed to a method comprising receiving, at a computing device including one or more processing units, a search query from a remote device. The method further comprises identifying a preliminary set of application state records, selecting a primary application state record from the preliminary set of application state records, and identifying an entity name and action associated with the primary application state record. The method further comprises identifying a secondary application state record from the preliminary set of application state records associated with the same entity name as the primary application state record and a different action than the primary application state record. Additionally, the method comprises generating a consolidated result based on the primary application state record and the second application state record and generating final search results based on the preliminary set of application state records. The final search results include the consolidated result in addition to the plurality of search results based on the preliminary set of application state records. The method further comprises transmitting the final search results to the remote device.

In another example, the present disclosure is directed to a system comprising one or more computing devices and a data store. The data store comprises one or more storage devices. The one or more computing devices comprise one or more processing units that execute computer-readable instructions, the computer readable instructions, when executed by the one or more processing units, cause the one or more computing devices to receive a search query from a remote device and identify, based on the search query, a preliminary set of application state records from a plurality of application state records stored in the data store. The one or more computing devices are further configured to select a primary application state record from the preliminary set of application state records, identify an entity name and action associated with the primary application state record, and identify a secondary application state record from the preliminary set of application state records. The secondary application state record is associated with the same entity name as the primary application state record and a different action than the primary application state record. The one or more computing devices are further configured to generate a consolidated result based on the primary application state record and the secondary application state record, generate final search results based on the preliminary set of application state records, and transmit the final search results to the remote device. The final search results include the consolidated result in addition to a plurality of search results based on the preliminary set of application state records.

### DESCRIPTION OF DRAWINGS

FIG. 1A is a schematic view of an example environment including a user device in communication with a search system, and an entity system.

FIG. 1B is a functional block diagram of a search system interacting with an entity system, user devices, and data sources.

FIG. 2A is a schematic view of an example user device in communication with a search system.

FIG. 2B is a functional block diagram of a search system interacting with an entity system.

FIG. 2C is a schematic view of example preliminary results.

FIG. 2D is a schematic view of an example user device displaying example final search results based on the example preliminary results of FIG. 2C.

FIGS. 3A and 3B are schematic views of an example user device displaying example final search results.

FIGS. 4A and 4B are schematic views of an example application state record.

FIGS. 5A and 5B are schematic views of an example entity record.

FIG. 6 illustrates an example method for generating final search results.

FIG. 7 illustrates an example method of receiving and displaying final search results at a user device.

FIG. 8 is a functional block diagram of an example search module.

FIG. 9 is a schematic view of an example user device executing a consolidation module via a search application.

FIG. 10 is a schematic view of an example computing device executing any systems or methods described herein.

Like reference symbols in the various drawings indicate like elements.

### DETAILED DESCRIPTION

The figures and following description relate to example implementations by way of illustration only. It should be noted that from the following discussion, alternative implementations of structures and methods disclosed herein will be readily recognized as viable alternatives that may be employed without departing from the scope of the disclosure.

The present disclosure relates to enhancing a preliminary set of search results by consolidating one or more of the preliminary search results into a consolidated search result that provides access to the underlying application states of multiple related preliminary search results. A preliminary set of search results (hereafter “preliminary set”) may be a set of search results that are ranked in an order for display in a search engine results page. A search result of a preliminary set may hereafter be referred to as a preliminary result. A preliminary result may be associated with an entity (e.g., a person, a place, or a thing) and an action (e.g., a task performed by the underlying application state of the preliminary result).

A search system of the present disclosure includes a consolidation module configured to generate a set of final search results including one or more consolidated search results. The consolidation module may generate a consolidated search result (hereafter “consolidated result”) by consolidating more than one preliminary result into a single search result. The consolidation module may select a preliminary result into which it will consolidate other preliminary results. A preliminary result into which other preliminary results are consolidated may be referred to herein as a primary result. The consolidation module may identify one or more preliminary results associated with the same entity, but a different action than a primary result and consolidate those preliminary results into the primary result. A user-selectable link associated with a preliminary result that has been consolidated into a primary result may hereafter be referred to as a secondary link. A user viewing a set of final search results displayed on a user device may conveniently access multiple application states related to the same entity using a consolidated result.

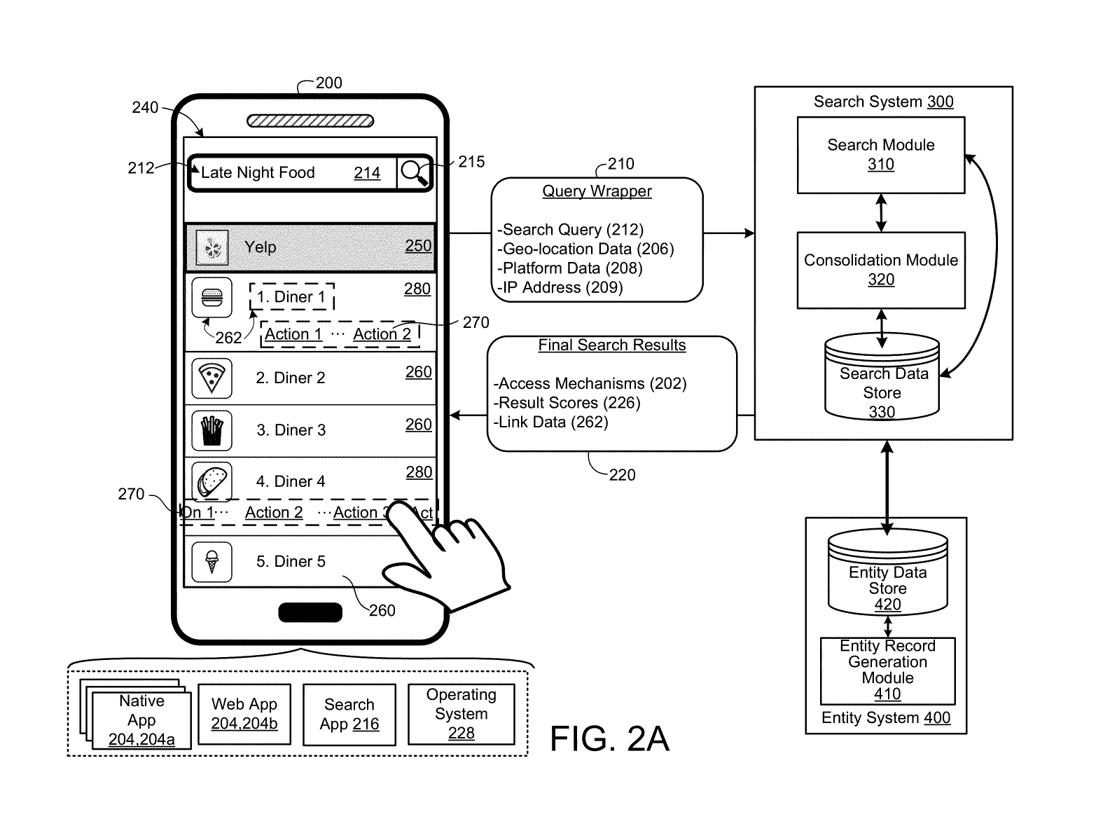

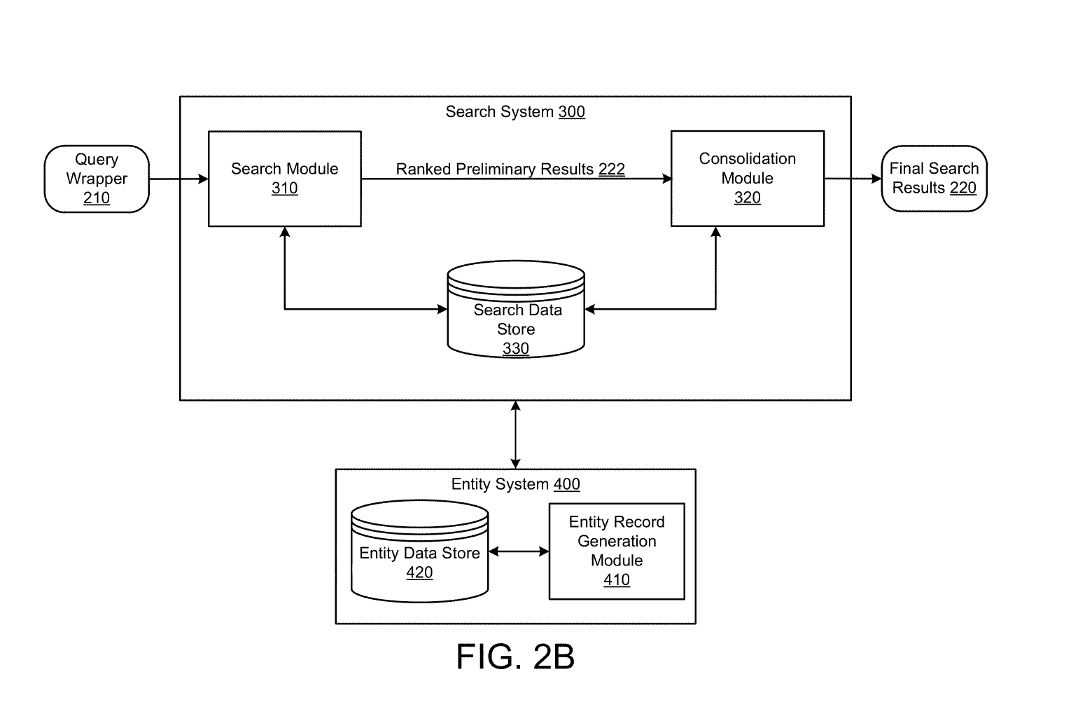

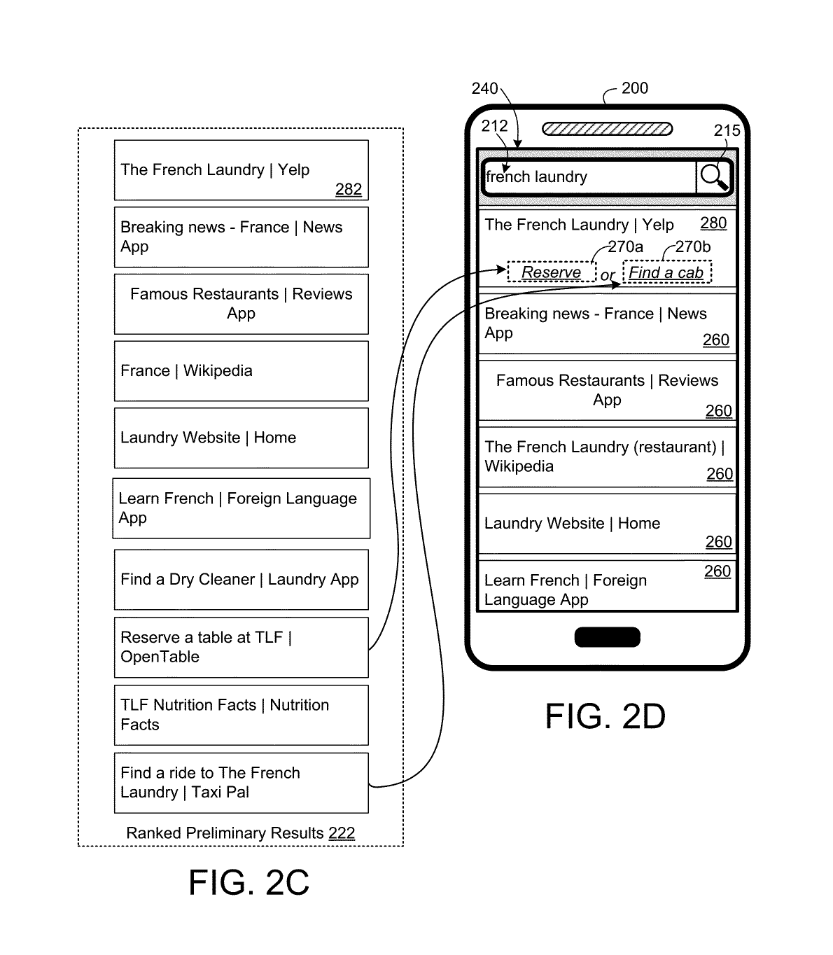

FIG. 2D illustrates an example user device displaying an example set of final search results 220 including one consolidated result 280. The final results 220 of FIG. 2D may be generated based on the preliminary results 222 of FIG. 2C. The preliminary results 222 of FIG. 2C appear in descending order according to their rank (e.g., the top result is the highest ranked preliminary result 222). In this example, a user may have entered the search query “french laundry” intending to find a taxi cab capable of driving the user to a famous restaurant, THE FRENCH LAUNDRY®. Therefore, the most relevant application state to the user may be a state of an application called “Taxi Pal” that allows the user to find a ride to THE FRENCH LAUNDRY®. In other words, as shown by FIG. 2C, the application state sought for by the user is the lowest ranked preliminary result 222. In this example, if the preliminary results 222 are not consolidated in the manner described herein, the user may stop scrolling through search result cards (e.g., text and/or images in the form of a user-selectable link contained within a boundary in a SERP) before locating the relevant search result. Instead, using the consolidation techniques described herein, the lowest ranked preliminary result 222 may be consolidated into the highest ranked preliminary result 222 because they share the same entity and are associated with different actions. In this way, the user may access a useful application state that may otherwise remain undiscovered due to its original rank and position in a set of search results.

In some implementations, the consolidation module may generate a consolidated result for each subset of preliminary results associated with the same entity. In some implementations, the consolidation module may determine one or more specific primary results for which to create consolidated results. In one example, the consolidation module may determine primary results based on their rank in the preliminary set. For example, the consolidation module may select the top N-ranked preliminary results as primary results, where N is a number greater than one. In another example, the consolidation module may select preliminary results associated with a particular entity type (e.g., restaurant entities) as primary results. In another example, the consolidation module may determine primary results to be the one or more preliminary results for which there are a threshold number of other preliminary results associated with the same entity. In some implementations, the one or more determined primary results into which other preliminary results are consolidated may be the highest ranked preliminary result of a subset of preliminary results associated with the same entity.

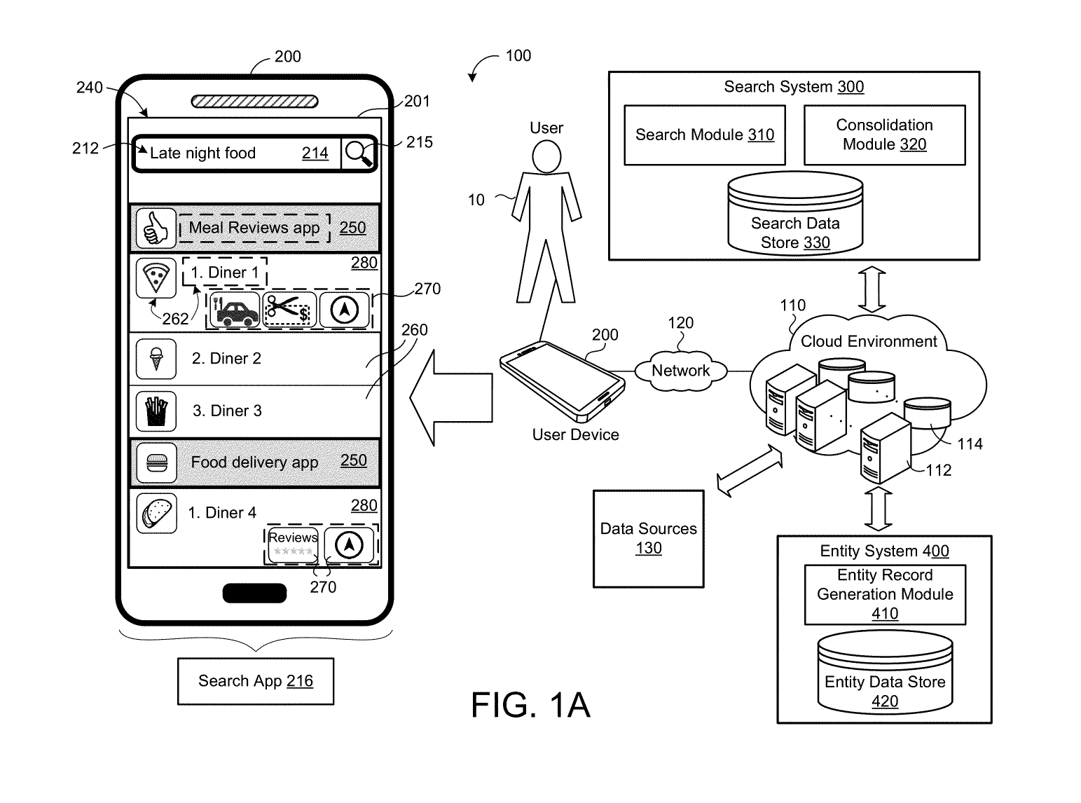

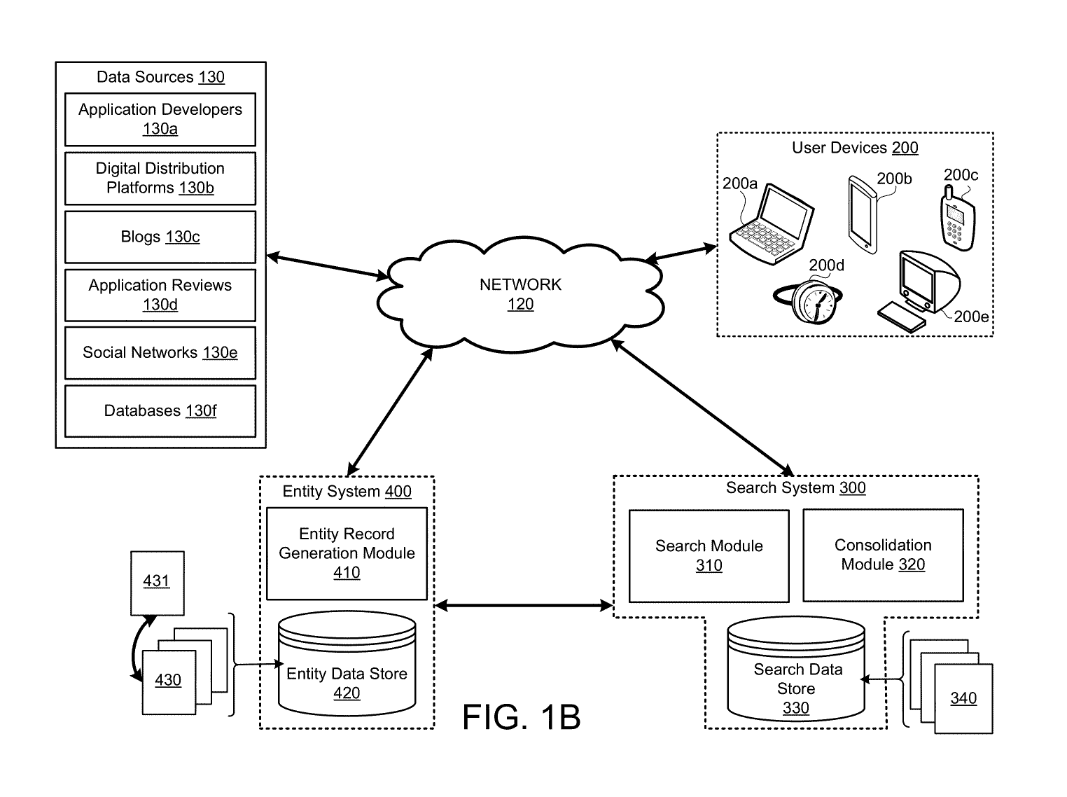

FIG. 1A illustrates an example environment 100 that includes a user device 200 associated with a user 10 in communication with a remote system 110 via a network 120. FIG. 1B provides a functional block diagram of the environment 100. The remote system 110 may be a distributed system (e.g., cloud environment) having scalable/elastic computing resources 112 and/or storage resources 114. The user device 200 and/or the remote system 110 may execute a search system 300 and an entity system 400, and optionally receive data from one or more data sources 130. In some implementations, the search system 300 and the entity system 400 communicate with one or more user devices 200 and the data source(s) 130 via the network 120. The network 120 may include various types of networks, such as a local area network (LAN), wide area network (WAN), and/or the Internet.

FIG. 2A illustrates an example user device 200 in communication with a search system 300 of the present disclosure. The search system 300 may include a search module 310, a consolidation module 320, and a search data store 330. The search system 300 may be in communication with an entity system 400. The entity system 400 includes an entity record generation module 410 in communication with an entity data store 420. The search system 300 may be configured to receive a query wrapper 210 (including a search query 212) from a user device 200. The user 10 may enter the search query 212 into a search field 214 (e.g., a search box) of a graphical user interface (GUI) 240 of a search application 216 running on the user device 200. A user 10 may enter a search query 212 using a touchscreen keypad, a mechanical keypad, a speech-to-text program, or other form of user input. The search system 300 may be configured to return final search results 220 based on the received query wrapper 210. The GUI 240 of the user device 200 may display the final search results 220 as a set of user-selectable links.

Upon display by the user device 200, a set of final search results 220 may include one or more displayed consolidated results 280 and one or more user-selectable links to unconsolidated results/links 260. An unconsolidated link 260 may be a user-selectable link to an underlying application state of a preliminary result 222 that was not consolidated by the search system 300. A displayed consolidated result 280 may be a user-selectable link to the underlying application state of a primary result 282 (i.e., a preliminary result 222 into which other preliminary results 222 are consolidated). A displayed consolidated result 280 may additionally include secondary links 270 that provide access to preliminary results 222 that have been consolidated into a primary result 282 based on the techniques described herein. Secondary links 270 provide access to application states related to the same entity, but a different action than the application state of the primary result 282. In this way, a relatively low ranked search result (e.g., a preliminary result 222) that may provide an action that a user seeks (e.g., find a ride to a specific restaurant).

In some implementations, such as in the example provided by FIG. 2A, the final results 220 may be organized under one or more headers 250, whereby links organized under a header correspond to application states of the application indicated by their corresponding header. In some implementations, such as in the example depicted by FIG. 2D, the final results 220 may be organized as search result cards, whereby each search result card (e.g., a user-selectable boundary including text and/or images) describes an underlying application state or, in the case of a consolidated result 280, multiple underlying application states.

Several examples of the present disclosure illustrate an example user device 200 in communication with the search system 300. User devices 200 can be any computing devices that are capable of providing search queries 212 to the search system 300. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances).

The user devices 200 may use a variety of different operating systems 228. In examples where a user device 200 is a mobile device, the user device 200 may run an operating system 228 including, but not limited to, ANDROID® developed by Google Inc., IOS® developed by Apple Inc., or WINDOWS PHONE® developed by Microsoft Corporation. Accordingly, the operating system 228 running on the user device 200 may include, but is not limited to, one of ANDROID®, IOS®, or WINDOWS PHONE®. In an example where a user device 200 is a laptop or desktop computing device, the user device 200 may run an operating system 228 including, but not limited to, MICROSOFT WINDOWS® by Microsoft Corporation, MAC OS® by Apple, Inc., or Linux. User devices 200 may also access the search system 300 while running operating systems 228 other than those operating systems 228 described above, whether presently available or developed in the future.

A software application 204 may refer to computer software that, when executed by a computing device, causes the computing device to perform a task. In some examples, a software application 204 may be referred to as an “application”, an “app”, or a “program”. Example software applications 204 include, but are not limited to, word processing applications, spreadsheet applications, messaging applications, media streaming applications, social networking applications, and games.

Applications 204 can be executed on a variety of different user devices 200. In some examples, a native application 204a may be installed on a user device 200 prior to a user 10 purchasing the user device 200. In other examples, the user 10 may download and install native applications 204a on the user device 200. Native applications 204a can perform a variety of different functions for a user 10. For example, a restaurant reservation application can make reservations for restaurants. As another example, an internet media player application can stream media (e.g., a song or movie) from the Internet. In some examples, a single native application 204a can perform more than one function. For example, a restaurant reservation application may also allow a user 10 to retrieve information about a restaurant and read user reviews for the restaurant in addition to making reservations. As another example, an internet media player application may also allow a user 10 to perform searches for digital media, purchase digital media, and generate media playlists.

The user 10 may access the functionality of an application 204 on the user device 200 on which the application 204 is installed. Additionally or alternatively, the user 10 may access the functionality of an application 204 via a remote computing device. In some examples, all of an application's functionality is included on the user device 200 on which the application 204 is installed. These applications 204 may function without communication with other computing devices (e.g., via the Internet). In additional examples, an application 204 installed on a user device 200 may access information from other remote computing devices during operation. For example, a weather application installed on a user device 200 may access the latest weather information via the Internet and display the accessed weather information to the user 10 through the installed weather application. In further examples, an application 204 may be partially executed by the user device 200 and partially executed by a remote computing device 300. For example, a web application may be an application 204 that is executed, at least in part, by a web server and accessed by a web browser application 204b of the user device 200. Example web applications may include, but are not limited to, web-based email, online auctions, and online retail sites.

A user device 200 may communicate with the search system 300 using any software application 204 that can transmit search queries 212 to the search system 300. In some examples, the user device 200 runs a native application 204a that is dedicated to interfacing with the search system 300, such as a native application 204a dedicated to searches (e.g., a search application 216). In some examples, the user device 200 communicates with the search system 300 using a more general application 204, such as a web application accessed using a web browser native application 204b. Although the user device 200 may communicate with the search system 300 using the native search application 216 and/or a web-browser application 204b, the user device 200 may be described hereinafter as using the native search application 216 to communicate with the search system 300. In some implementations, the functionality attributed to the search application 216 may be included as a searching component of a larger application 204 that has additional functionality. For example, the functionality attributed to the search application 216 may be included as part of a native application 204a or a web application 204b as a feature that provides search capabilities.

The user device 200 generates and displays user-selectable links based on the received final search results 220. Each user selectable link displayed to the user 10 may correspond to an access mechanism 202 (described in detail herein). The user 10 may select a user-selectable link on the user device 200 by interacting with the link (e.g., touching or clicking the link). In response to selection of a link, the user device 200 may launch a corresponding software application 204 (e.g., a native application 204a or a web-browser application 204b) referenced by the access mechanism 202 and perform one or more operations indicated by the access mechanism 202.

FIG. 2B depicts a functional block diagram illustrating an example search system 300 of the present disclosure. The search system 300 includes a search module 310, a consolidation module 320, and a search data store 330. The search system 300 may be in communication with an entity system 400. The entity system 400 includes an entity record generation module 410 in communication with an entity data store 420. The search data store 330 and the entity data store 420 may each include one or more databases, indices (e.g., inverted indices), tables, files, or other data structures, which may be used to implement the techniques of the present disclosure.

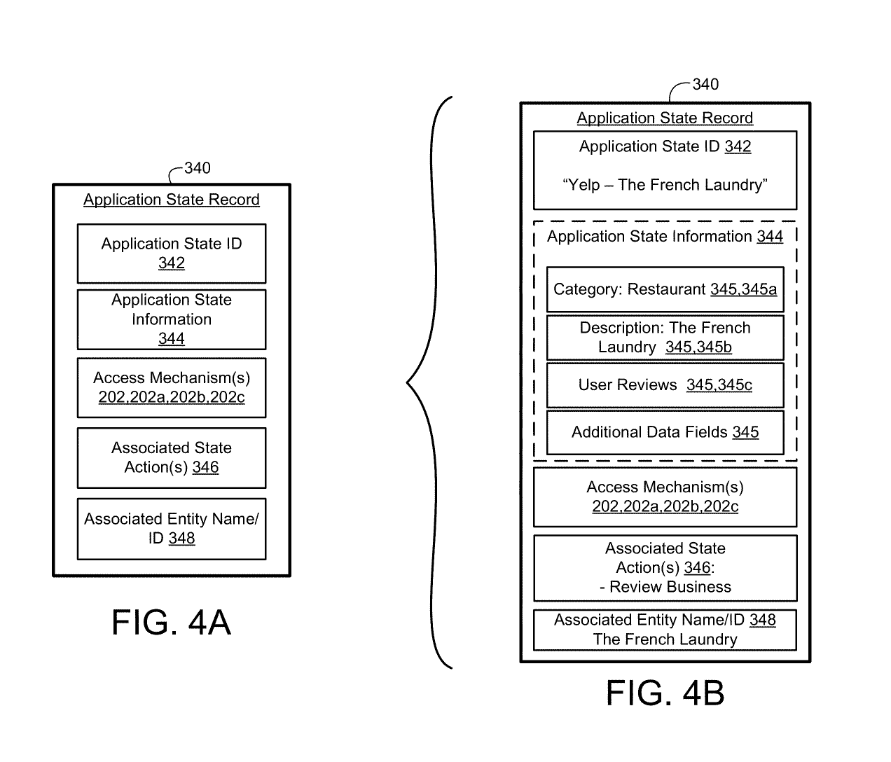

The search module 310 may be configured to receive a query wrapper 210 and generate ranked preliminary results 222 based on data included in the search data store 330. In some implementations, the search module 310 can receive a query wrapper 210 from the user device 200 and perform a search for application state records 340 included in the search data store 330 based on data included in the query wrapper 210, such as a search query 212. The application state records 340 (discussed with respect to FIGS. 4A and 4B) may be used to generate a set of ranked preliminary results 222 and may include one or more access mechanisms 202 that a user device 200 can use to access different functions for a variety of different applications, such as native applications 204a installed on the user device 200.

The search module 310 may be configured to receive a query wrapper 210 from a user device 200 via the network 120. A query wrapper 210 may include a search query 212, which may include text, numbers, and/or symbols (e.g., punctuation) entered into the user device 200 by the user 10. A search query 212 may be a request for information retrieval (e.g., search results) from the search system 300. In some examples, the user 10 enters a search query 212 into a search field 214 of the GUI 240 and the GUI 240 displays final search results 220 (via the search application 216) as the user 10 is inputting the text. In other examples, the user 10 selects a search button 215 causing the GUI 240 to display final search results 220. A search query 212 may be directed to retrieving a list of links to application functionality or application states. A search query 212 directed to retrieving a list of links to application functionality may indicate a user's desire to access functionality of one or more applications 204 described by the search query 212 and displayed in the header 250.

The query wrapper 210 may include additional data along with the search query 212. For example, the query wrapper 210 may include geo-location data 206 that indicates the location of the user device 200, such as latitude and longitude coordinates. The user device 200 may include a global positioning system (GPS) receiver that generates the geo-location data 206 transmitted in the query wrapper 210. The query wrapper 210 may also include an IP address 209, which the search system 300 (e.g., the search module 310) may use to determine the location of the user device 200. In some examples, the query wrapper 210 may also include additional data, including, but not limited to, platform data 208 (e.g., version of the operating system 228, device type, and web-browser version), an identity of a user 10 of the user device 200 (e.g., a username), partner specific data, and other data.

The search module 310 (FIG. 2B) performs a search for application state records 340 included in the search data store 330 in response to the received query wrapper 210. In some implementations, the search module 310 generates result scores 226 for application state records 340 identified during the search. The result score 226 associated with an application state record 340 may indicate the relevance of the application state record 340 to the search query 212. A higher result score 226 may indicate that the application state record 340 is more relevant to the search query 212. In some implementations, the search module 310 may transmit ranked preliminary results 222 to the consolidation module 320 by transmitting pairs of access mechanisms and result scores, whereby each access mechanism and result score pair indicates a ranked preliminary result. In these examples, the search module 310 may retrieve access mechanisms 202 from the scored application state records 340. The search module 310 may output a result score 226 along with an access mechanism 202 retrieved from a scored application state record 340 in order to indicate the rank of the access mechanism 202 among other outputted access mechanisms 202. In some implementations the search module 310 may transmit ranked preliminary results 222 by transmitting pairs of application state IDs 342 and a corresponding result score. In these examples, the consolidation module 320 may retrieve data associated with the ranked preliminary results 222 by accessing the search data store 330 and/or the entity data store 420 based on a corresponding access mechanism 202 or application state ID 342.

The search module 310 may include additional data in the ranked preliminary results 222. The consolidation module 320 may transmit the additional data to the user device 200 along with the access mechanisms 202 and the result score(s) 226. For example, the search module 310 may transmit data (e.g., text and/or images) to be included in the user selectable links of the final search results 220. Data for the user selectable links (e.g., text and/or images) may be referred to herein as link data 262. The user device 200 displays the user selectable links to the user 10 based on received link data 262. Each user-selectable link may be associated with an access mechanism 202 included in the final search results 220, such that when a user 10 selects a link, the user device 200 launches the application 204 referenced in the access mechanism 202 and sets the application 204 into the state specified by the access mechanism 202.

The consolidation module 320 may be in communication with the search data store 330 and the entity data store 420. The consolidation module 320 may receive the set of ranked preliminary results 222 from the search module 310 and identify one or more primary results 282. A primary result 282 may be a preliminary result 222 into which the consideration module 320 may consolidate other preliminary results 222, thereby creating a consolidated result 280. The consolidation module 320 may then identify subsets of preliminary results 222 associated with the same entity as a primary result 282, but a different action than the primary result 282. The consolidation module 320 may generate one or more consolidated results 280 by consolidating the identified subsets of preliminary results 222 into the one or more primary results 282. The consolidation module 320 may generate final search results 220 based on the consolidated results 280 and the remaining preliminary results 222 (e.g., the preliminary results 222 that were not consolidated into a primary result 282). In some implementations, consolidated results 280 may assume the rank (e.g., result score 226) of their corresponding primary result 282 in the final search results 220. The consolidation module 320 (or a downstream component of the search system 300) transmits the final search results 220 to the user device 200.

In some implementations, the consolidation module 320 may not generate any consolidated results 280. For example, the consolidation module 320 may not identify any subsets of preliminary results 222 associated with the same entity. In these examples, the consolidation module 320 may transmit final search results 220 not including consolidated results 280. In some implementations, the consolidation module 320 may generate a specified number of consolidated results 280. For example, the consolidation module 320 may be configured to generate a predefined minimum or maximum number of consolidated results (e.g., at least three or at most three). In some implementations, the consolidation module 320 may be configured to generate a consolidated result 280 for every subset of preliminary results 222 associated with the same entity. In this example, the highest ranking preliminary result 222 of each subset may be determined to be a primary result 282 into which the other preliminary results 222 of the subset are consolidated.

In some implementations, the consolidation module 320 may determine primary results 282 for which to generate consolidated results 280. In other words, the consolidation module 320 may select one or more preliminary results 222 (i.e., primary results 282) into which to consolidate other preliminary results 222, thereby creating a consolidated result 280. The consolidation module 320 may determine primary results 282 in a number of ways. In some implementations, the consolidation module 320 may be configured to select primary results 282 based on their corresponding rank (e.g., result score 226). For example, the consolidation module 320 may select the top N-ranked preliminary results 222 to be primary results 282, where N may be an integer greater than zero.

In some implementations, the consolidation module 320 may determine primary results 282 based on an entity 431 or entity category 438. For example, a system operator of the search system 300 may define a list of entities or entity categories (e.g., “restaurants”) for which to generate consolidated results 280. In another example, a list of entities or entity categories may be automatically generated based on popular application states identified by the search system 300. In these examples, the highest ranked preliminary result 222 associated with an entity or entity category in the list may be selected by the consolidation module 280 to be a primary result 282. In another example, the consolidation module 320 may determine primary results 282 based on the entity 431 or entity category 438 associated with the highest number of preliminary results 222. For example, the entity category 438 “football teams” may be associated with more preliminary results 222 of a particular preliminary set than any other entity category associated with the preliminary set. In this example, the consolidation module 320 may select the highest ranked preliminary result 222 associated with the entity category “football teams” to be a primary result 282. In scenarios where the consolidation module 320 selects primary results 282 based on an entity 431 or entity category 438, the consolidation module 320 may access the entity system 400 (e.g., the entity data store 420) to retrieve one or more entity records 400. In some implementations, the consolidation module 320 may acquire the data required to perform the techniques described herein solely from the application state records 340 of the application state data store 400.

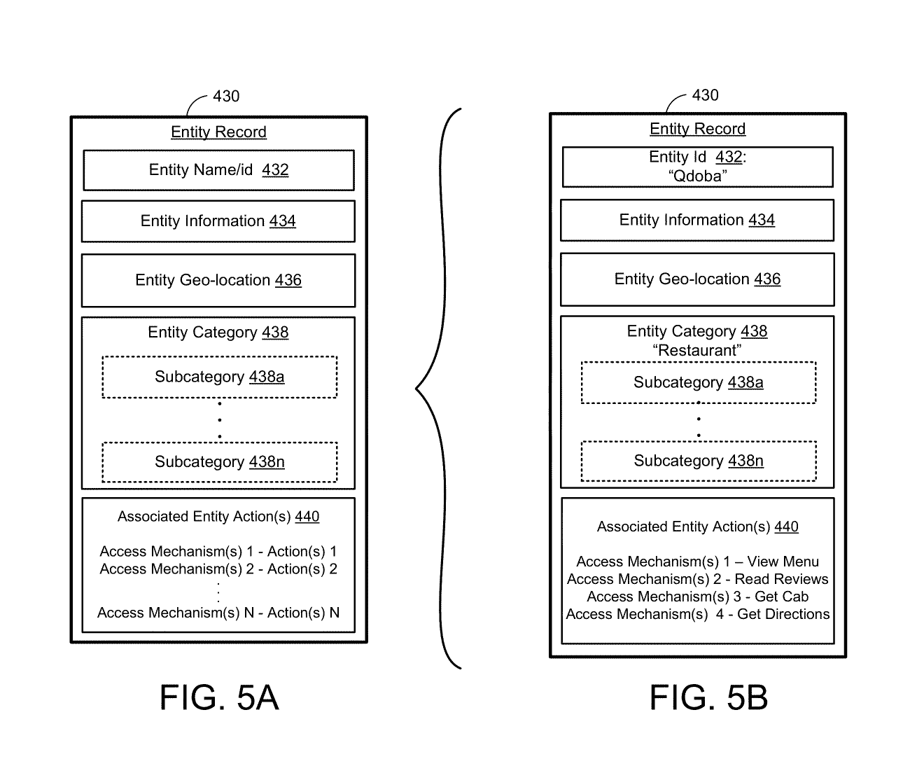

The application state records 340 and the entity records 430 include one or more access mechanisms 202 that the user device 200 can use to access different functions for a variety of different applications 204, such as native applications 204a installed on the user device 200. The application state records 340 and entity records 430 may additionally include data that may be used to generate link data 262 that may be used to render and display the final search results 220 in a search engine results page (hereafter “SERP”). Application state records 340, entity records 430, and the data therein are described in more detail below with respect to FIGS. 4-5. The search system 300 transmits the final search results 220 including one or more consolidated results 280, link data 262, and a list of access mechanisms 202 to the user device 200 that generated the query wrapper 210.

FIG. 2C illustrates an example set of preliminary results 222 generated in response to the search query 212 “french laundry”. FIG. 2D illustrates a user device 200 displaying an example set of final results 220 generated based on the preliminary results 222 of FIG. 2C. For ease of explanation, the preliminary results 222 of FIG. 2C have been illustrated in a human-readable manner, such as they may appear after render and display by a user device 200. The ranked preliminary results 222 of FIG. 2C may be illustrated in descending order according to their rank.

In order to generate the final search results 220 of FIG. 2D, the consolidation module 320 may select one or more primary results 282 into which to consolidate other preliminary results 222 associated with the same entity. In this example, the consolidation module 320 may be configured to generate a single consolidated result 280 for the highest ranked preliminary result 222. Based on this configuration, the consolidation module 320 may determine that the preliminary result 222 associated with an application state of YELP® (a business review application developed by Yelp, Inc.) related to THE FRENCH LAUNDRY® may be the designated primary result 282. In response to this designation, the consolidation module 320 may identify an entity associated with each of the preliminary results 222. The consolidation module 320 may identify one or more preliminary results 222 associated with the same entity, but a different action than the designated primary result 282.

In some implementations, the consolidation module 320 may be configured to retrieve one or more application state records 340 associated with one or more preliminary results 222 (e.g., using access mechanisms and/or application state IDs 342 transmitted in the ranked preliminary results 222 by the search module 310). In these examples, the consolidation module 320 may identify an entity associated with a particular preliminary result 222 based on the associated entity name/ID 348 in a preliminary result's 222 corresponding application state record 340. Additionally or alternatively, the consolidation module 320 may identify an action associated with a particular preliminary result 222 based on the associated state action(s) 346 in a preliminary result's 222 corresponding application state record 340. In some implementations, the consolidation module 320 may be configured to retrieve one or more entity records 430 associated with the entities 431 of one or more preliminary results 222. In these examples, the consolidation module 320 may utilize the entity records 430 to determine an entity category 438 of an entity associated with a preliminary result 222. In this way, the consolidation module 320 may consolidate preliminary results 222 based on data included in the application state data store 330 and the entity data store 420.

Returning to the example of FIG. 2D, the consolidation module 320 identified a first and second preliminary result 222 associated with the same entity as the primary result 282 but a different action than the primary result 282. The first preliminary result 222 may provide access to an application state of the restaurant reservation application OPENTABLE® (developed by OpenTable, Inc.). More specifically, the first preliminary result 222 may provide access to an application state of the OPENTABLE® application that provides the action of allowing the user to reserve a table at THE FRENCH LAUNDRY®. The second preliminary result 222 may provide access to an application state of the taxi cab application “Taxi Pal.” More specifically, the second preliminary result 222 may provide access to an application state of the “Taxi Pal” application that allows the user to find a ride to THE FRENCH LAUNDRY®. As depicted by the example of FIG. 2D, the consolidation module 320 may generate a consolidated result 280. The consolidated result 280 may include user-selectable secondary links 270a, 270b to the first and second preliminary results 222 (e.g., preliminary results 222 associated with the same entity and different action than the designated primary result 282). The user device 200 may be precluded from rendering the preliminary results 222 corresponding to the links 270a, 270b as individual, unconsolidated user-selectable links 260 because they are accessible via the consolidated result 280.

In some implementations, the consolidation module 320 may identify more potential secondary links 270 (e.g., links to underlying application states of preliminary results 220 associated with the same entity but different actions than a primary result 282) than it is capable of displaying in a consolidated result 280. In some implementations, the consolidation module 320 may be configured to generate consolidated results 280 including a limited number of secondary links 270. In these implementations, the consolidation module 320 may be configured to select which secondary links 270 to include in a consolidated result 280. In some implementations, the consolidation module 320 may select the secondary links 270 associated with the highest ranked preliminary results 222 for inclusion in a consolidated result 280. The consolidation module 320 may select between the secondary links 270 based on any suitable metric associated with the preliminary results 222.

FIG. 2D illustrates example final search results 220 generated based on the preliminary results 222 of FIG. 2C. The search system 300 may configure a set of final search results 220 to be rendered and displayed on a user device 200 as user-selectable links. As described herein, the search system 300 transmits additional data (e.g., via the consolidation module 320) in the final search results 220 along with application access mechanisms 202a. For example, the search system 300 may transmit data (e.g., link data 262, such as text and/or images), which may be used by the user device 200 to generate user-selectable links in the final search results 220. A link may include text and/or images that the user 10 may select (e.g., touch) via a user interface 240 displayed on a screen 201 (e.g., a display or touch screen) of the user device 200. Each user selectable link may be associated with an application access mechanism 202a such that when the user 10 selects a link, the user device 200 launches the native application 204a referenced in the application access mechanism 202a and performs the one or more operations indicated in the application access mechanism 202a. The text and/or images of a link displayed to the user 10 may indicate the operations that will be performed in response to selection of the link. For example, if the link is to a song in a music playing application, the text and/or images may identify the music application that will be launched by the user device 200 and the song that will be played by the music playing application when the user 10 selects the link. In some implementations, the consolidation module 320 may be configured to determine the format or order in which secondary links 270 appear in a consolidated result 280. For example, the consolidation module 320 may determine that a particular secondary link 270 must appear as an image in the left-most available space of a consolidated result 280. In another example, the consolidation module 320 may determine that each secondary link 270 may be displayed as a textual description of the action accomplished by the underlying application state of the secondary link 270. In these examples, the consolidation module 320 may include information in the link data 262 instructing the user device 200 to render and display the secondary links 270 in a specific location or format accordingly.

The user 10 may select a link 260, 270, 280 to cause the user device 200 to launch the native application 204a identified in the link 260, 270, 280 and perform one or more operations according to the application access mechanism 202a associated with the link. Put another way, when the user 10 selects a link the user device 200 launches a native application 204a and sets the native application 204a into a state defined by the application access mechanism 202a associated with the link. In general, a state of a native application 204a may refer to the operations and/or the resulting outcome (e.g., the specific site/screen) of the native application 204a in response to selection of a link 250, 260, 270. For example, if a native application 204a is configured to retrieve and display information from the Internet, the native application 204a can be set into a state in which the native application 204a retrieves information from the Internet and displays information to the user 10. A state of a native application 204a may also be referred to herein as an “application state.”

A web access mechanism 202b may include a resource identifier that includes a reference to a web resource (e.g., a page of a web application/website). For example, a web access mechanism 202b may include a uniform resource locator (URL) (i.e., a web address) used with hypertext transfer protocol (HTTP). If a user 10 selects a user selectable link 250, 260, 270 including a web access mechanism 202b, the user device 200 may launch the web browser application 204b and retrieve the web resource indicated in the resource identifier. Put another way, if a user 10 selects a user selectable link 250, 260, 270 including a web access mechanism 202b, the user device 200 may launch a corresponding web-browser application 204b and access a state (e.g., a page) of a web application/website. In some examples, web access mechanisms 202b include URLs for mobile-optimized sites and/or full sites.

The web access mechanism 202b included in an application state record 340 may be used by a web browser to access a web resource that includes similar information and/or performs similar functions as would be performed by a native application 204a that receives an application access mechanism 202a of the application state record 340. For example, the web access mechanism 202b of an application state record 340 may direct the web-browser application 204b of the user device 200 to a web version of the native application 204a referenced in the application access mechanisms 202a of the application state record 340. In one example, if the application access mechanisms 202 included in an application state record 340 for a specific Mexican restaurant cause each application edition to retrieve information for the specific Mexican restaurant, the web access mechanism 202b may direct the web-browser application 204b of the user device 200 to a web page entry for the specific Mexican restaurant.

An application download mechanism 202c may indicate a location (e.g., a digital distribution platform 130b) where a native application 204a can be downloaded in the scenario where the native application 204a is not installed on the user device 200. If a user 10 selects a user selectable link 250, 260, 270 including an application download mechanism 202a, the user device 200 may access a digital distribution platform from which the referenced native application 204a may be downloaded. The user device 200 may access a digital distribution platform 130b using at least one of the web-browser application 204b and one of the native applications 204a. In some implementations, the user selectable links 250, 260, 270 may include web access mechanisms for the user device to use for accessing the link instead of downloading the native application from the digital distribution platform.

In some implementations, an access mechanism 202 included in an application state record 340 and/or an entity record 430 may be a dynamic access mechanism. In these examples, an application state record 340 and/or an entity record 430 may store an access mechanism template instead of a completed access mechanism. In these examples, the search system 300 and/or entity system 400 may utilize data provided by a user device 200, such as geo-location data included in a query wrapper, to populate fields of an access mechanism template and thereby create a completed access mechanism 202. In another example, the search system 300 and/or entity system 400 may utilize contextual data such as the time at which a search query 212 was received to complete an access mechanism template. In another example, the search system 300 and/or entity system 400 may prompt a user of a user device 200 to provide more information in order to provide a completed access mechanism 202. In this way, the access mechanisms 202 discussed herein may be dynamic access mechanisms that may be completed using access mechanism templates and data retrieved from a user device, or in some examples, generated at the search system 300 and/or entity system 400.

In some examples, the search application 216 may be a native application 204a installed on the user device 200. The search application 216 may receive search queries 212, generate the query wrapper 210, and display received data that is included in the final search results 220. In additional examples, the user device 200 may execute a web-browser application 204b that accesses a web-based search application. In this example, the user may interact with the web-based search application via a web-browser application 204b installed on the user device 200. In still more examples, the functionality attributed to the search application 216 may be included as a searching component of a larger application 204 that has additional functionality. For example, the functionality attributed to the search application 216 may be included as part of a native/web-browser application 204a, 204b as a feature that provides search for the native/web-browser application 204a, 204b.

The user device 200 may receive a set of final search results 220 from the search system 300 in response to the transmission of the query wrapper 210 to the search system 300. The GUI 240 of the search application 216 displays the final search results 220 received from the consolidation module 320. The search application 216 may display the final search results 220 to the user 10 in a variety of different ways, depending on what information is transmitted to the user device 200. In examples where the final search results 220 include a list of access mechanisms 202 and link data 262, the search application 216 may display the final search results 220 to the user 10 as a list of user selectable links 260, 270, 280 including text and images. The user selectable links 260, 270, 280 may include user-selectable links 260 associated with unconsolidated preliminary results 222, and secondary user-selectable links 270 associated with the consolidated preliminary results 222. User-selectable links 280 (i.e., consolidated results 280) may provide access to a primary result 282 of a set of preliminary results 222. The text and images in the links 260, 270, 280 may include application names associated with the access mechanisms 202, text describing the access mechanisms 202, images associated with the application 204 referenced by the access mechanisms 202 (e.g., application icons), and images associated with the application state (e.g., application screen images) defined by the access mechanisms 202. One or more secondary user-selectable link(s) 270 can be associated with a primary user-selectable link 260.

In some implementations, the search application 216 displays the final search results 220 as a list of user-selectable links including one or more displayed consolidated results 280 arranged under the search field 214 in which the user 10 entered the search query 212. In these examples, and each consolidated result 280 may include one or more secondary links 270 associated with the displayed consolidated result 280. Moreover, the search application 216 may arrange the user-selectable links based on the final search results 220 in order based on the rank (e.g., result score 226) associated with a user-selectable link's underlying preliminary result 222. In addition, the search application 216 may organize the secondary links 270 in order based on result score 226, action, or other metric indicated by the consolidation module 320. In some examples, the search application 216 groups the user-selectable links together if the links are related to the same application 204 displayed in the header 250. In some implementations, the secondary links 270 appearing in a displayed consolidated result 280 may not correspond to the same application as the associated primary result 282. In these examples, the search application 216 may display the final search results 220 as a list of search result cards (e.g., FIG. 2D). In this way, a consolidated result 280 may provide access to several different applications (e.g., the application of the primary result 282 and the application(s) of the preliminary results 222 corresponding to the secondary links 270).

Each of the user-selectable links (e.g., the displayed consolidated result 280, secondary links 270, and unconsolidated links 260) may be generated based on link data 262. For example, each user-selectable link includes link data 262 such as an image (e.g., an icon) and text (e.g., an application or business name) that may describe an application and/or a state of an application. Each of the links 260, 270, 280 may include an access mechanism 202 such that if a user 10 selects one of the links 260, 270, 280 the user device 200 launches the application and sets the application into a state that is specified by the access mechanism 202 associated with the selected link 260, 270, 280. In some implementations, the user device 200 may arrange the user-selectable links 260, 270, 280 based on result scores associated with the access mechanisms 202 included in the links 260, 270, 280. In some implementations, a consolidated link 280 may assume the rank of its associated primary result. For example, as shown by FIGS. 2C and 2D, the primary result 282 may be first in a set of ranked preliminary results 222. In this example, the corresponding consolidated result 280 may assume the rank of first, thereby appearing first among a list of displayed final search results 200.

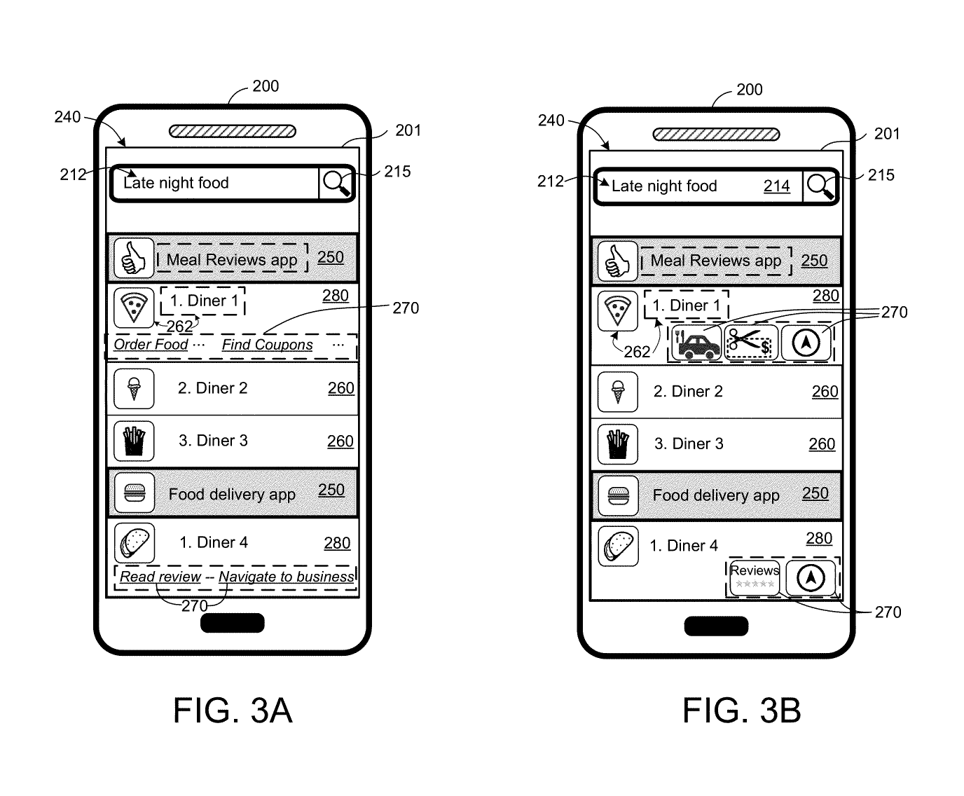

Referring to FIGS. 3A-3B, in general, the GUI 240 displays the secondary links 270 within consolidated results 280, thereby indicating that the secondary links 270 are related to the entity 431 of the displayed consolidated result 280. For example, a secondary link 270 may be displayed proximate to a consolidated result 280 (e.g., within the same defined area as shown in FIGS. 3A-3B). In these examples, the secondary links 270 may be displayed along within consolidated results 280 such that a first consolidated result 280 and a first set of secondary links 270 are displayed together, whereby the secondary links 270 are displayed either above, below, or adjacent the content of a consolidated result 280. In some examples, a second consolidated result 280 associated with a second application includes a second set of secondary links 270. As shown in FIG. 3A, the secondary links 270 are displayed as textual descriptions of an action. However, in FIG. 3B the secondary links 270 are displayed as icons that indicate an action. Other methods of displaying the links are possible as well.

In some examples, user devices 200 communicate with the search system 300 via a partner computing system (not illustrated). The partner computing system may be a computing system of a third party that may leverage the search functionality of the search system 300. The partner computing system may belong to a company or organization other than that which operates the search system 300. Example third parties, which may leverage the functionality of the search system 300 may include, but are not limited to, internet search providers and wireless communications service providers. The user devices 200 may send search queries to the search system 300 and receive results via the partner computing system. The partner computing system may provide a user interface to the user devices 200 in some examples and/or modify the search experience provided on the user devices 200.

Referring back to FIG. 1B, the data sources 130 may be sources of data, which the search system 300 (e.g., the search module 310) may use to generate and update the search data store 330 and entity data store 420. The data retrieved from the data sources 130 can include any type of data related to application functionality and/or application states. Data retrieved from the data sources 130 may be used to create and/or update one or more databases, indices, tables (e.g., an access table), files, or other data structures included in the search data store 330 and entity data store 420. For example, application state records 340 and entity records 430 may be created and updated based on data retrieved from the data sources 130. In some examples, some data included in a data source store 340, 420 may be manually generated by a human operator. Data included in the application state records 340 and entity records 430 may be updated over time so that the search system 300 provides up-to-date results.

The data sources 130 may include a variety of different data providers. The data sources 130 may include data from application developers 130a, such as application developers' websites and data feeds provided by developers. The data sources 130 may include operators of digital distribution platforms 130b configured to distribute native applications 204a to user devices 200. Example digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications. Additionally, the data sources 130 may include social networking sites 130e, such as “FACEBOOK®” by Facebook, Inc. (e.g., Facebook posts) and “TWITTER®” by Twitter Inc. (e.g., text from tweets). Data sources 130 may also include online databases 130f that include, but are not limited to, data related to movies, television programs, music, and restaurants. Data sources 130 may also include additional types of data sources in addition to the data sources described above. Different data sources 130 may have their own content and update rate.

The entity system 400 includes an entity record generation module 410 and an entity data store 420 (e.g., non-transitory memory). The entity data store 420 stores entity records 430, each associated with an entity 431. An entity 431 may refer to a person, place, or thing. For example, an entity 431 may refer to a business, product, service, media content, political organization/figure, public figure, destination, or any other suitable item of commerce. An application state (e.g., accessed via an access mechanism 202) may perform actions related to an entity 431. For example, referring to the GUI 240 shown in FIG. 1A, the meal review application (e.g., YELP® developed by Yelp, Inc.,) relating to Diner 1 (e.g., McDonald's restaurant) is associated with an entity 431 “Diner 1” (e.g., “McDonald's Restaurant”). The entity record generation module 410 generates entity records 430 (FIGS. 5A-5B) from the data sources 130 by identifying entities 431 associated with one or more application states. Each entity record 430 may include data related to an entity 431. In some examples, an entity 431 is referenced by more than one application state.

In some implementations, an action ontology may be stored by the search system 300 and entity system 400 in the form of a list of actions corresponding to application states. The search system 300 and the entity system 400 can use the action ontology to assign actions to their respective records (e.g., application state records 340 and entity records 430). For example, the search system 300 may include one or more modules (not shown) that can assign actions to application state records 340. As another example, the entity system 400 may utilize the entity record generation module 410 and/or one or more modules (not shown) to assign actions to entity records. The action ontology may be defined by a system operator. In some examples, the system operator can create an action ontology specific to the search system 300 and entity system 400. In other examples, the system operator may select actions from an existing ontology such as one provided by schema.org (maintained by Google, Inc., Yahoo, Inc., Microsoft Corporation, and Yandex). In this way, actions may be assigned to application states manually and/or automatically.

In some examples, application states may be marked up (e.g., tagged) with actions by third parties (e.g., application and/or website owners/developers other than those that operate the search system 300 and the entity system 400). In these examples, the search system 300 and the entity system 400 can utilize the marked up actions to assign actions to application states. In other examples, the system operator may assign actions to application states and web pages at the application and domain level, respectively. For example, a food review application may be assigned the action “read review.” The search system 300 and entity system 400 may then assign the application-level action “read reviews” across every state of the food review application automatically. In a different example, the system operator may assign actions to application states and web pages individually (e.g. a sample size of different states/pages). The search system 300 and entity system 400 can then assign actions to similar states in the application/website. For example, the system operator can manually assign the action “read review” to a state/page and replicate this assignment across other states/pages at the same level in the application/website (e.g., all states/pages related to reading reviews). More specifically, if the action related to the manually-assigned state/page relates to reading reviews about restaurants, any other states also related to reading reviews about restaurants will automatically be assigned the same action as the manually-assigned state/page. As another specific example, if a state/page of a movie database application/website relates to specific movie information, that state/page can be assigned the action “read movie information” manually by the system operator. The search system 300 and entity system 400 may then apply the action “read movie information” across the rest of the states/pages of the movie database application/website that allow a user to view information related to a specific movie.

In some examples, an application state may correspond to one or more actions. Example actions may include, but are not limited to: Navigate to a location, Find transportation to a location, Provide restaurant information, Order food from a restaurant, Provide food photos, Show menu, Find a business, Provide reviews of business, Provide food recipes, Send message, Check stocks, Check weather, Check sports scores, Play music, Play movie, Listen to radio station(s), Record video, Provide discount.

FIGS. 4A and 4B illustrate an example application state record 340. The search data store 340 may include a plurality of different application state records 340. Each application state record 340 may include data related to a state of an application 204. An application state record 340 may include an application state identifier (ID) 342, application state information 344, one or more access mechanisms 202, 202a, 202b, 202c used to access states of the application 204, associated state actions (s) 346, and associated entity name(s)/ID(s) 348.

The application state ID 342 may be used to identify the application state record 340 among the other application state records 340 included in the search data store 340. The application state ID 342 may be a string of alphabetic, numeric, and/or symbolic characters (e.g., punctuation marks) that uniquely identifies the associated application state record 340. In some examples, the application state ID 342 describes an application state in human readable form. In some examples, the application state ID 342 includes a string in the format of a uniform resource locator (URL) of a web access mechanism 202b or an application access mechanism 202a for the application state record 340, which may uniquely identify the application state record 340.

In a more specific example, if the application state record 340 describes a function of the YELP® native application 204a, the application state ID 342 may include the name “Yelp” along with a description of the application state described in the application state information 344. For example, in FIG. 4B, the application state ID 342 for an application state record 340 that describes the restaurant named “The French Laundry” may be “Yelp—The French Laundry.” In an example where the application state ID 342 includes a string in the format of a URL, the application state ID 342 may include the following string “http://www.yelp.com/biz/the-french-laundry-yountville-2?ob=1” to uniquely identify the application state record 340.

The application state information 344 may include data that describes an application state into which an application 204 is set according to the access mechanism(s) 202 in the application state record 340. The application state information 344 can include text, numbers, and symbols that describe the application state. The types of data included in the application state information 344 may depend on the type of information associated with the application state specified by the application access mechanism 202a. The application state information 344 may include a variety of different types of data, such as structured, semi-structured, and/or unstructured data. The application state information 344 may be automatically and/or manually generated based on documents retrieved from the data sources 130. Moreover, the application state information 344 may be updated so that up-to-date final search results 220 can be provided in response to a search query 212.

In some examples, the application state information 344 includes data that may be presented to the user 10 by an application 204 when the application 204 is set in the application state defined by the access mechanism(s) 202. For example, if one of the access mechanism(s) 202 is an application access mechanism 202a, the application state information 344 may include data that describes a state of the native application 204a after the user device 200 has set the application in the state specified by the application access mechanism 202a. For example, if the application state record 340 is associated with a shopping application, the application state information 344 may include data that describes products (e.g., names and prices) that are shown when the shopping application is set to the application state defined by the access mechanism(s) 202. As another example, if the application state record 340 is associated with a music player application, the application state information 344 may include data that describes a song (e.g., name and artist) that is played when the music player application is set to the application state defined by the access mechanism(s) 202.

The types of data included in the application state information 344 may depend on the type of information associated with the application state specified by the access mechanism(s) 202. For example, if the application state record 340 is for an application 204 that provides reviews of restaurants, the application state information 344 may include information (e.g., text and numbers) related to a restaurant, such as a category of the restaurant, reviews of the restaurant, and a menu for the restaurant. In this example, the access mechanism(s) 202 may cause the application 204 (e.g., a native application 204a or a web-browser application 204b) to launch and retrieve information for the restaurant. As another example, if the application state record 340 is for an application 204 that plays music, the application state information 344 may include information related to a song, such as the name of the song, the artist, lyrics, and listener reviews. In this example, the access mechanism(s) 202 may cause the application 204 to launch and play the song described in the application state information 344. In some cases, the application state information 344 may also include information about the application (e.g., developer name, application category, and application statistics).

The search system 300 may generate application state information 344 included in an application state record 340 in a variety of different ways. In some examples, the search system 300 retrieves data to be included in the application state information 344 via partnerships with database owners and developers of native/web applications 204a. For example, the search system 300 may automatically retrieve the data from online databases 130f that include, but are not limited to, data related to movies, television programs, music, and restaurants. In some examples, a human operator manually generates some data included in the application state information 344. In some examples, a human operator may configure the search system 300 to automatically crawl native and web application states to obtain application state information. The search system 300 may update data included in the application state information 344 over time in order to provide up-to-date final search results 220.

The example application state information 344 of FIG. 4B includes data fields 345, such as a category 345a of THE FRENCH LAUNDRY® restaurant, a description 345b of THE FRENCH LAUNDRY® restaurant, user reviews 345c of THE FRENCH LAUNDRY® restaurant, and additional data fields 345. The restaurant category 345a field may include the text “French cuisine” and “contemporary,” for example. The description field 345b may include text that describes THE FRENCH LAUNDRY® restaurant. The user reviews field 345c may include text of user reviews for THE FRENCH LAUNDRY® restaurant. The additional data fields 345 may include additional data for THE FRENCH LAUNDRY® restaurant that may not specifically fit within the other defined fields, such as a menu for the restaurant, prices, and operating hours for the restaurant.

The associated state action(s) 346 identifies an action associated with the application access mechanism(s) of the application state record 340. For example, if the application state record 340 is for an application that provides restaurant reviews, then the associated state action 346 is “Review Business.” As another example, if the application state record 340 is for an application state that provides directions to a location, then the associated state action 346 may be “Navigate To.” Returning to the example application state record 340 illustrated by FIG. 4B, an associated state action 346 for the application state record 340 of the Yelp application state related to THE FRENCH LAUNDRY® may be “review business”.

The associated entity name/ID 348 (hereinafter “associated entity name 348”) identifies an entity 431 associated with the application state described by the application state record 340. For example, if the application state record 340 is for an application state that includes a review for a restaurant, then the associated entity name 348 may be the name of the restaurant. As another example, if the application state record 340 is for an application state that provides directions to a location, then the associated entity name 348 may be the location that the application state is navigating to. In FIG. 4B, the associated entity name for the application record 340 is ‘The French Laundry”, which is the name of the restaurant (i.e., entity 431) associated with the application state described by the application state record 340.

The application state record 340 includes access mechanisms for accessing the application state on a variety of different platforms. For example, the access mechanisms 202 may include at least one of an application access mechanism 202a, a web access mechanism 202, and an application download mechanism 202c. The application state record 340 may include application access mechanisms for one or more editions of the native application. An application edition may refer to a version of a native application 204a, such as a version 1.0 of a native application 204a or a version 2.0 of a native application 204a. In another example, an application edition may refer to an implementation of a native application 204a for a specific platform, such as a specific operating system 228 or device type. The different application access mechanisms 202 included in an application state record 340 may cause the corresponding application editions to launch into similar states. In some examples, the search system 300 can determine whether to transmit the application access mechanism 202 in the final search results 220 based on whether the user device 200 can handle the application access mechanism 202. For example, the search system 300 can select compatible application access mechanisms 202a for transmission or can transmit web access mechanisms 202b when the applications are not installed on the user device 200.

Referring to FIGS. 5A and 5B, the entity data store 420 includes a plurality of different entity records 430. Each entity record 430 may include data related to an entity 431. The entity 431 can be any person, place, or thing. For example, an entity 431 may correspond to a celebrity. In another non-limiting example, such as in the case of a place or location, an entity may correspond to a restaurant, bar, gas station, supermarket, movie theater, doctor office, park, or library. As another example, an entity may be any suitable item of commerce referred to, described, or otherwise indicated by an application state. An entity record 430 may include an entity name/identifier (ID) 432, entity location data 436 (e.g., geolocation data), an entity category 438 (and optionally one or more sub-categories 438a-438n), entity information 434, and associated entity actions 440.

The entity ID 432 may be used to identify the entity record 430 among the other entity records 430 included in the entity data store 420. The entity ID 432 may be a string of alphabetic, numeric, and/or symbolic characters (e.g., punctuation marks) that uniquely identifies the associated entity record 430. In some examples, the entity ID 432 describes the entity 431 in human readable form. For example, the entity ID 432 may include the name of the entity 431.

In a more specific example, if the entity record 430 describes a restaurant named Qdoba® (QDOBA is a registered trademark of Qdoba Restaurant Corporation), the entity ID 432 for the entity record 430 can be “Qdoba.” In an example where the entity ID 432 includes a string in human readable form, the entity ID 432 may include the string “Qdoba” along with other identifying information, such as a specific restaurant number, address, or other unique identification in order to uniquely identify the entity record 430.

The entity information 434 may include any information about the entity 431, such as text (e.g., description, reviews) and numbers (e.g., number of reviews). The entity information 434 may include a variety of different types of data, such as structured, semi-structured, and/or unstructured data. Moreover, the entity information 434 may be automatically and/or manually generated based on documents retrieved from the data sources 130. For example, the entity record generation module 410 may generate and update the entity records 430 based on data retrieved from the data sources 130.

The entity location data 436 may include data that describes a location of the entity 431. This data may include a geolocation (e.g., latitude and longitude coordinates), a street address, or any information that can be used to identify the location of the entity 431 within a geographical area.

The entity category 438 provides a classification or grouping of the entity 431. The entity category can have one or more sub-categories to further classify the entity 431. For example, the entity record 430 could have an entity category 438 of “restaurant” and a sub-category 438a type of cuisine, such as “Mexican cuisine” or “burritos.” Any number of sub-categories 438a-438n may be assigned to classify the entity 431 for use during a search.

The associated entity action(s) 440 provide one or more actions associated with the entity ID 432. For example, the associated entity action(s) may be a list of application state IDs 342 and/or access mechanisms 202 and their corresponding action. Each access mechanism 202 and/or application state ID appearing in a list included in the associated entity actions 440 corresponds to an action, and each action may be related to a different application. For example, the entity record 430 may be associated with entity 431 that is a restaurant as shown in FIG. 5B. The associated entity action(s) 440 for the entity “Qdoba” may include an access mechanism 202 for the OPENTABLE® application 204 and be associated with the action “View Menu”. Another associated entity action 440 for the “Qdoba” entity may be “Read Reviews” and correspond to an application state of the YELP® application. The associated entity action(s) may include access mechanisms 202 or application state IDs 342 for any application states that perform an action related to the entity “Qdoba.”

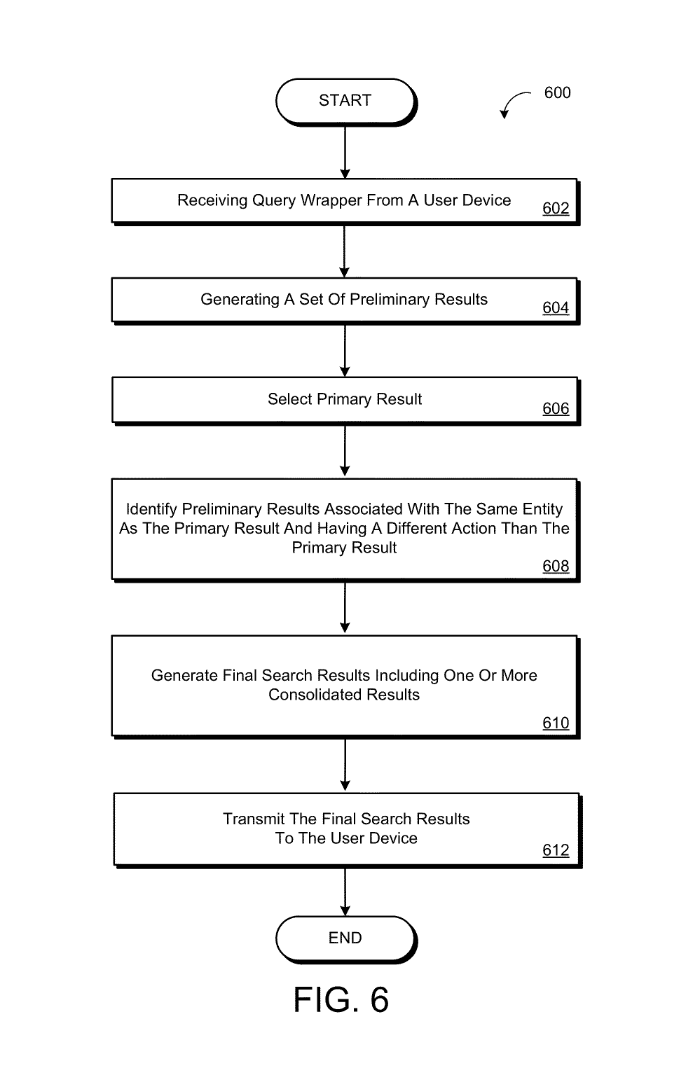

FIG. 6 provides an example arrangement of operations for a method 600 of generating final search results 220 using the search system 300 of FIG. 2B. At block 602, the method 600 includes receiving a query wrapper 210 from a user device 200. At block 604, the method 600 includes generating a set of preliminary results 222 based on the received query wrapper 210. At block 606, the method 600 includes selecting a primary result 282 from the set of preliminary results 222. In some examples, the selection of the primary results 282 may be determined based on a threshold number of primary results 222a having a highest result score 222. At block 608, the method 600 includes identifying one or more preliminary results 222 associated with the entity 431 of the primary result 282 and having a different action than the action of the primary result 282. At block 610, the method 600 includes generating final search results 220 that include the consolidated results 280. Finally, at block 612, the method 600 includes transmitting the final search results 220 to the user device 200.

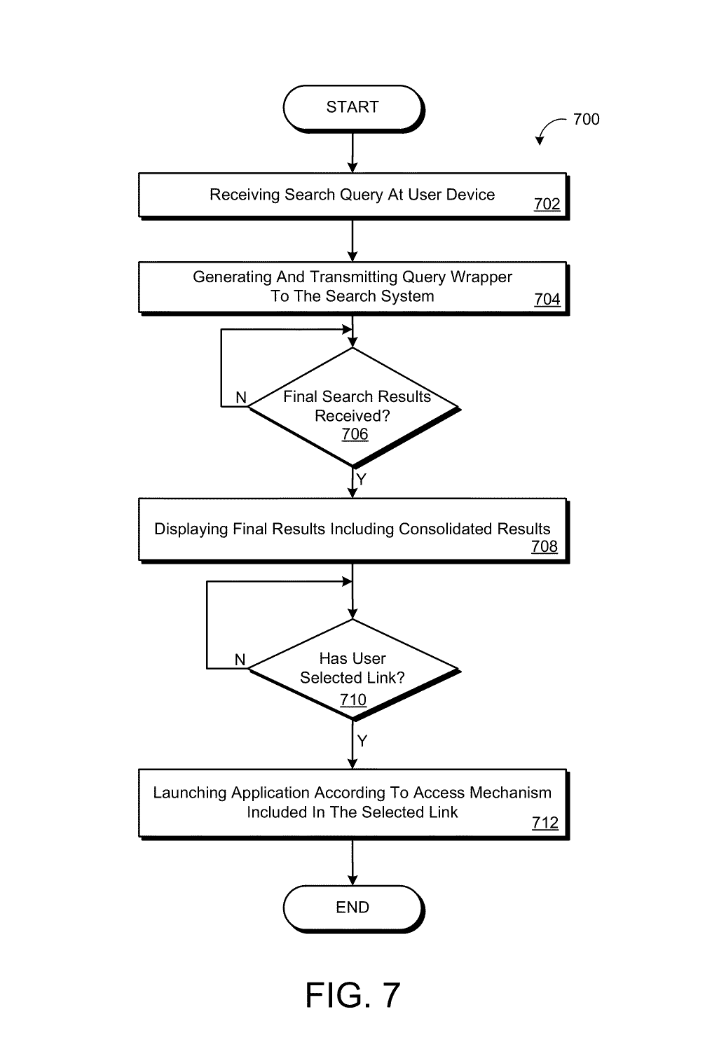

FIG. 7 provides an example arrangement of operations for a method 700 of performing a search and displaying final search results 220 including consolidated results 280 on a user device 200 of FIGS. 2A and 2B. At block 702, the method 700 includes receiving a search query at the user device 200 from a user 10 of the user device. At block 704, the method 700 includes generating a query wrapper 210 and transmitting it to a search system 300. At decision block 706, the method 700 includes determining if final search results 220 are received from the search system 300. At block 708, and after the final search results 220 are received, the method 700 includes generating user-selectable links 260, 270, 280 associated with the received final search results 220. The received final search results 220 may include link data 262 for displaying a consolidated result 280, a secondary link 270, or an unconsolidated link 260. At block 710, the method 700 determines when a user 10 selects a link. At block 712, when the user 10 selects a link, the method 700 includes launching an application 204 according to the access mechanism 202 indicated by the selected link 260, 270, 280.

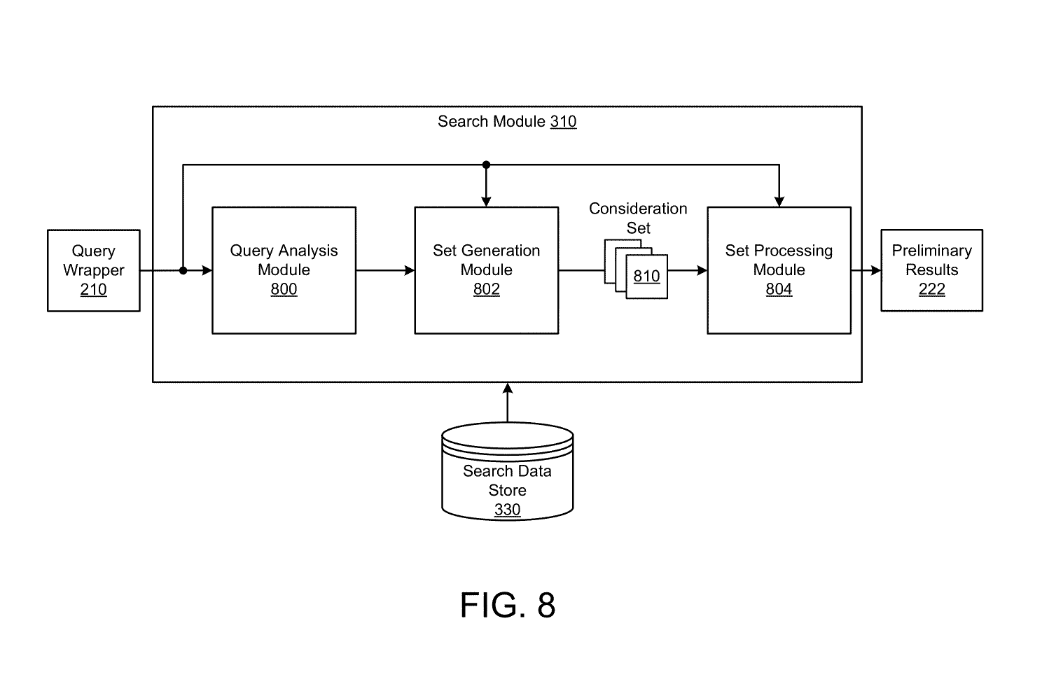

FIG. 8 shows an example search module 360 that includes a query analysis module 800, a consideration set generation module 802 (hereinafter “set generation module 802”), and a consideration set processing module 804 (hereinafter “set processing module 804”). The example search module of FIG. 8 may be used to generate a set of preliminary search results 222. The query analysis module 800 receives the query wrapper 210 and analyzes the received search query 212. The query analysis module 800 may perform various analysis operations on the received search query 212, which may include, but are not limited to, tokenization of the search query 212, filtering of the search query 212, stemming, synonymization, and stop word removal. In some implementations, the query analysis module 800 detects a query-specified location included in the search query 212.

The set generation module 802 identifies a plurality of application state records 340 based on the received search query 212. In some examples, the set generation module 802 identifies the application state records 340 based on matches between terms of the search query 212 and terms in the application state records 340. For example, the set generation module 802 may identify the application state records 340 based on matches between tokens generated by the query analysis module 800 and words included in the application state records 340, such as words included in the application state IDs 342 and/or the application state information 344.

The consideration set 810 of application state records 340 may refer to the application state records 340 that are to be scored by the set processing module 804. The set generation module 802 may determine the geo-location of the user device 200 based on data included in the query wrapper 210. In additional examples, if the query analysis module 800 detects a query-specified location, the set generation module 802 uses the query-specified location as the search location. In some examples, the set generation module 802 uses the geo-location of the user device 200 as the search location (e.g., to filter application state records 340 based on location).

The set processing module 804 may score the application state records 340 in the consideration set 810 in order to generate a set of ranked preliminary results 222. The scores 226 associated with the application state records 340 may be referred to as “result scores.” The set processing module 804 may determine a result score 226 for each of the application state records 340 in the consideration set 810. The result scores 226 associated with an application state record 340 may indicate the relative rank of the application state record 340 (e.g., by the access mechanisms 202) among other application state records 340. For example, a larger result score 226 may indicate that an application state record 340 is more relevant to the received search query 212.

The set processing module 804 selects application access mechanisms 202 from the selected application state records 340 (e.g., the highest scoring application state records). The set processing module 804 transmits the selected application access mechanisms 202 to the consolidation module 320. The set processing module 804 may also transmit the result scores 226 associated with the selected application access mechanisms 202. For example, an application access mechanism 202 may be associated with the result score 226 of the application state record 340 from which the application access mechanism 202 was selected.

The information conveyed by the preliminary results 222 may depend on how the result scores 226 are calculated by the set processing module 804. For example, the result scores 226 may indicate the relevance of an application function or application state to the search query 212, the popularity of an application function or state, or other properties of the application function or state, depending on what parameters the set processing module 804 uses to score the application state records 340.

The set processing module 804 may generate result scores 226 for application state records 340 in a variety of different ways. In some implementations, the set processing module 804 generates a result score 226 for an application state record 340 based on one or more scoring features. The scoring features may be associated with the application state record 340 and/or the search query 212. A record scoring feature may be based on any data associated with an application state record 340. For example, record scoring features may be based on any data included in the application state information 344 of the application state record 340. Example record scoring features may be based on metrics associated with a person, place, or thing described in the application state record 340. Example metrics may include the popularity of a place described in the application state record 340 and/or ratings (e.g., user ratings) of the place described in the application state record 340. For example, if the application state record 340 describes a song, a metric may be based on the popularity of the song described in the application state record 340 and/or ratings (e.g., user ratings) of the song described in the application state record 340. The record scoring features may also be based on measurements associated with the application state record 340, such as how often the application state record 340 is retrieved during a search and how often access mechanisms 202 of the application state record 340 are selected by a user 10. Record scoring features may also be based on whether the application state record 340 includes an application access mechanism 202 that leads to a default state or a deeper native application state.

A query scoring feature may include any data associated with the search query 212. For example, query scoring features may include, but are not limited to, a number of words in the search query 212, the popularity of the search query 212, and the expected frequency of the words in the search query 212. A record-query scoring feature may include any data generated based on data associated with both the application state record 340 and the search query 212 that resulted in identification of the application state record 340 by the set generation module 802. For example, record-query scoring features may include, but are not limited to, parameters that indicate how well the terms of the search query 212 match the terms of the application state information 344 of the identified application state record 340. The set processing module 804 may generate a result score 226 for an application state record 340 based on at least one of the record scoring features, the query scoring features, and the record-query scoring features.

The set processing module 804 may determine a result score 226 for an application state record 340 based on one or more of the scoring features listed herein and/or additional scoring features not explicitly listed. In some examples, the set processing module 804 may include one or more machine learned models (e.g., a supervised learning model) configured to receive one or more scoring features. The one or more machine learned models may generate result scores 226 based on at least one of the record scoring features, the query scoring features, and the record-query scoring features. For example, the set processing module 804 may pair the search query 212 with each application state record 340 and calculate a vector of features for each (query, record) pair. The vector of features may include one or more record scoring features, one or more query scoring features, and one or more record-query scoring features. The set processing module 804 may then input the vector of features into a machine-learned regression model to calculate a result score for the application state record 340. In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

The result scores 226 associated with the application state records 340 (e.g., access mechanisms 202) may be used in a variety of different ways. The set processing module 804 and/or the user device 200 may rank the access mechanisms 202 based on the result scores 226 associated with the access mechanisms 202. In these examples, a larger result score may indicate that the access mechanism 202 (e.g., the function or application state) is more relevant to a user than an access mechanism 202 having a smaller result score.

Modules and data stores included in the search system 300 and/or entity system 400 represent features that may be included in the search system 300 and/or entity system 400 of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

In some implementations, the search system 300 and the entity system 400 may be a system of one or more computing devices (e.g., a computer search system) that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the search system 300 and the entity system 400 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the search system 300 and the entity system 400 may be configured to communicate with the network 120. The one or more computing devices of the search system 300 may also be configured to communicate with one another (e.g., via a computer network). In some examples, the one or more computing devices of the search system 300 may include one or more server computing devices configured to communicate with user devices (e.g., receive query wrappers and transmit results), gather data from data sources 130, index data, store the data, and store other documents. The one or more computing devices may reside within a single machine at a single geographic location in some examples. In other examples, the one or more computing devices may reside within multiple machines at a single geographic location. In still other examples, the one or more computing devices of the search system 300 may be distributed across a number of geographic locations.

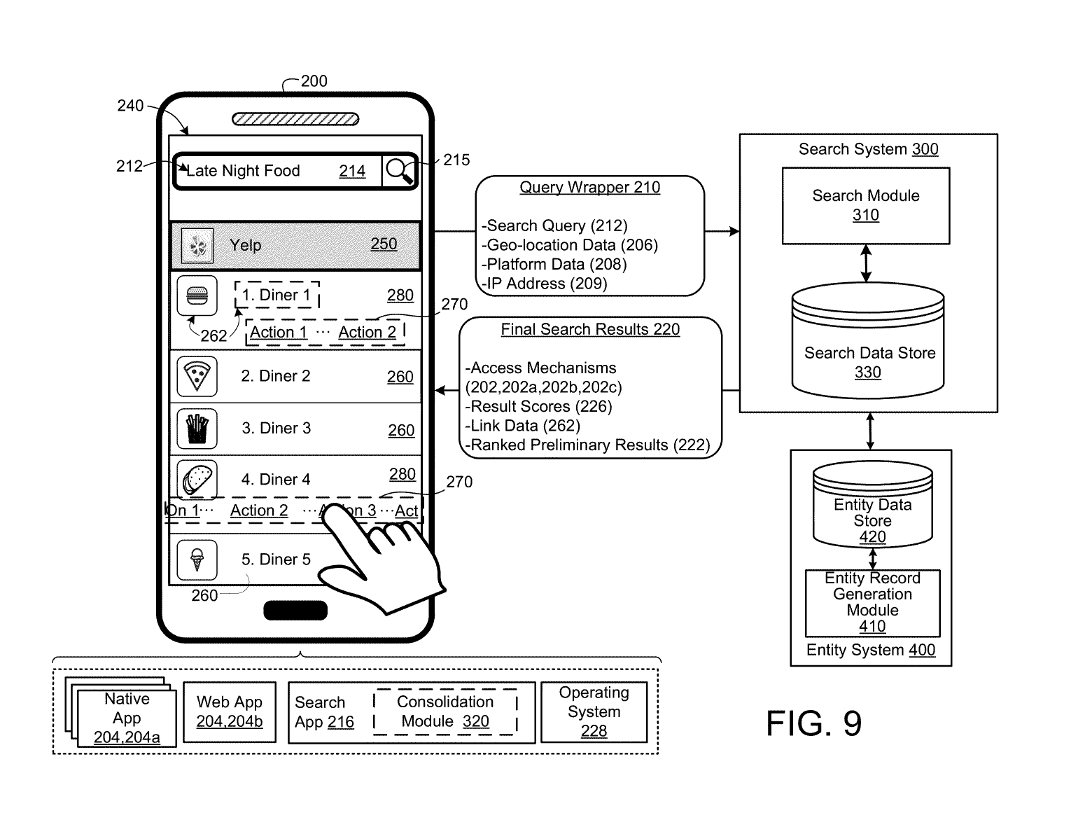

Referring to FIG. 9, in some implementations, a native application 204 installed on the user device 200 may implement some of the functionality described herein as being attributed to the consolidation module 320 of the search system 300. For example, the search application 216 may implement the functionality of a consolidation module 320. In these examples, the search application 216 may receive a set of final search result 220 including preliminary results 222 and consolidate the preliminary results 222 according to the techniques described herein by executing a consolidation module 320 at the user device 200.

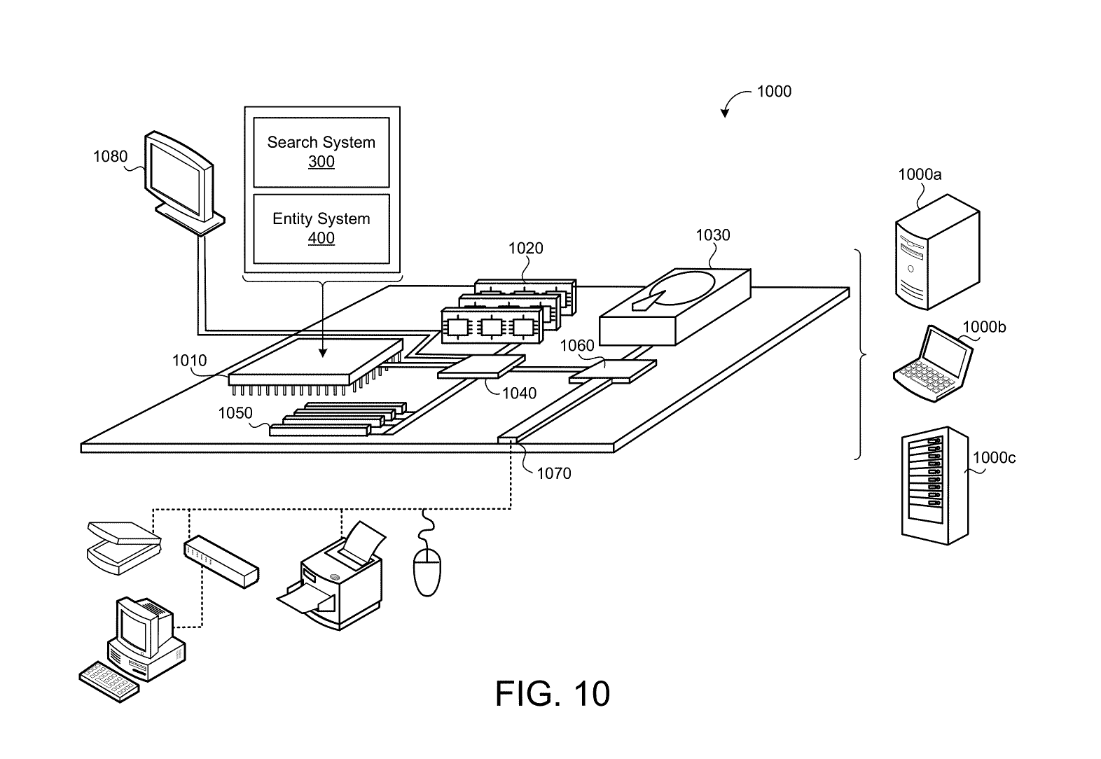

FIG. 10 is schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1000 includes a processor 1010, memory 1020, a storage device 1030, a high-speed interface/controller 1040 connecting to the memory 1020 and high-speed expansion ports 1050, and a low speed interface/controller 1060 connecting to low speed bus 1070 and storage device 1030. Each of the components 1010, 1020, 1030, 1040, 1050, and 1060, are interconnected using various busses, and may be mounted on a common motherboard or in other manners as appropriate. The processor 1010 can process instructions for execution within the computing device 1000, including instructions stored in the memory 1020 or on the storage device 1030 to display graphical information for a graphical user interface (GUI) on an external input/output device, such as display 1080 coupled to high speed interface 1040. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1020 stores information non-transitorily within the computing device 1000. The memory 1020 may be a computer-readable medium, a volatile memory unit(s), or non-volatile memory unit(s). The non-transitory memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1030 is capable of providing mass storage for the computing device 1000. In some implementations, the storage device 1030 is a computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1020, the storage device 1030, or memory on processor 1010.

The high speed controller 1040 manages bandwidth-intensive operations for the computing device 1000, while the low speed controller 1060 manages lower bandwidth-intensive operations. Such allocation of duties is exemplary only. In some implementations, the high-speed controller 1040 is coupled to the memory 1020, the display 1080 (e.g., through a graphics processor or accelerator), and to the high-speed expansion ports 1050, which may accept various expansion cards (not shown). In some implementations, the low-speed controller 1060 is coupled to the storage device 1030 and low-speed expansion port 1070. The low-speed expansion port 1070, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 1000 may be implemented in a number of different forms, as shown in the figure. For example, it may be implemented as a standard server 1000a or multiple times in a group of such servers 1000a, as a laptop computer 1000b, or as part of a rack server system 1000c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a computing device including one or more processing units, a search query from a remote device;
identifying, by the computing device, a preliminary set of application state records;
selecting, by the computing device, a primary application state record from the preliminary set of application state records;
identifying, by the computing device, an entity name and an action associated with the primary application state record;
identifying, by the computing device, a secondary application state record from the preliminary set of application state records associated with the same entity name as the primary application state record and a different action than the primary application state record;
generating, by the computing device, a consolidated result based on the primary application state record and the secondary application state record;
generating, by the computing device, final search results based on the preliminary set of application state records, wherein the final search results include the consolidated result in addition to a plurality of search results based on the preliminary set of application state records; and
transmitting, by the computing device, the final search results to the remote device.

2. The method of claim 1, wherein the preliminary set of application state records is stored in a data store, and wherein identifying the preliminary set of application state records comprises matching terms of the search query to terms included in the application state records.

3. The method of claim 1, wherein the consolidated result and the plurality of final search results are configured to be displayed as user-selectable links.

4. The method of claim 1, wherein the secondary application state record is included in the preliminary set of application state records.

5. The method of claim 1, wherein the primary application state record comprises application state information describing a primary application state associated with the primary application state record, a primary access mechanism that causes a user device to launch the primary application state, and a primary action and a primary entity associated with the primary application state, wherein the secondary application state record comprises application state information describing a secondary application state associated with the secondary application state record, a secondary access mechanism that causes a user device to launch the secondary application state, and a secondary action and a secondary entity associated with the secondary application state, wherein the primary entity name and secondary entity name are the same, and wherein the primary action and secondary action are different.

6. The method of claim 5, wherein at least one of the primary and secondary application state records includes an access mechanism configured to receive additional parameters associated with the search query, the method further comprising generating a completed access mechanism based on the access mechanism and the additional parameters.

7. The method of claim 5, wherein selecting the secondary application state record comprises determining that the primary entity name is the same as the secondary entity name and that the primary action is different than the secondary action.

8. The method of claim 5, wherein the consolidated result includes the access mechanism of the primary application state record and the access mechanism of the secondary application state record.

9. The method of claim 1, wherein selecting the secondary application state record comprises identifying a secondary set of application state records and selecting the secondary application state record from the secondary set of application state records.

10. The method of claim 9, wherein selecting the primary application state record comprises selecting, by the processing system, an application state record based on an entity category associated with the entity names of the preliminary set.

11. A system comprising:
a data store comprising one or more storage devices;
one or more computing devices including one or more processing units that execute computer-readable instructions, the computer readable instructions, when executed by the one or more processing units, cause the one or more computing devices to:
receive a search query from a remote device;
identify a preliminary set of application state records from the data store;
select a primary application state record from the preliminary set of application state records;
identify an entity name and an action associated with the primary application state record;
identify a secondary application state record from the preliminary set of application state records associated with the same entity name as the primary application state record and a different action than the primary application state record;
generate a consolidated result based on the primary application state record and the secondary application state record;
generate final search results based on the preliminary set of application state records, wherein the final search results include the consolidated result in addition to a plurality of search results based on the preliminary set of application state records; and
transmit the final search results to the remote device.

12. The system of claim 11, wherein the one or more computing devices are configured to identify the preliminary set of application state records by matching terms of the search query to terms included in the application state records.

13. The system of claim 11, wherein the consolidated result and the plurality of final search results are configured to be displayed as user-selectable links.

14. The system of claim 11, wherein the secondary application state record is included in the preliminary set of application state records.

15. The system of claim 11, wherein the primary application state record comprises application state information describing a primary application state associated with the primary application state record, a primary access mechanism that causes a user device to launch the primary application state, and a primary action and a primary entity associated with the primary application state, wherein the secondary application state record comprises application state information describing a secondary application state associated with the secondary application state record, a secondary access mechanism that causes a user device to launch the secondary application state, and a secondary action and a secondary entity associated with the secondary application state, wherein the primary entity name and secondary entity name are the same, and wherein the primary action and secondary action are different.

16. The system of claim 15, wherein at least one of the primary and secondary application state records includes an access mechanism configured to receive additional parameters associated with the search query, and wherein the one or more computing devices are configured to generate a completed access mechanism based on the access mechanism and the additional parameters.

17. The system of claim 15, wherein the one or more computing devices are configured to select the secondary application state record by determining that the primary entity name is the same as the secondary entity name and that the primary action is different than the secondary action.

18. The system of claim 15, wherein the consolidated result includes the access mechanism of the primary application state record and the access mechanism of the secondary application state record.

19. The system of claim 11, wherein the one or more computing devices are configured to select the secondary application state record by identifying a secondary set of application state records and selecting the secondary application state record from the secondary set of application state records.

20. The system of claim 19, wherein the one or more computing devices are configured to select the primary application state record by selecting an application state record based on an entity category associated with the entity names of the preliminary set.
